(19) United States
(12) Patent Application Publication
(10) Pub. No.: US 2004/0268306 A1
(43) Pub. Date: Dec. 30, 2004

(54) Methods, systems and computer program products for language independent data communication and display

(76) Inventors: Ken Prayoon Cheng, Saratoga, CA (US); Kong Li, San Jose, CA (US); Masahito Kagawa, Sunnyvale, CA (US); Toru Mori, Santa Rosa, CA (US)

Correspondence Address: MYERS BIGEL SIBLEY & SAJOVEC, PO BOX 37428, RALEIGH, NC, 27627, US

(21) Appl. No.: 10/609,987

(22) Filed: Jun. 30, 2003

(51) Int. Cl. G06F 9/44

(52) U.S. Cl. 717/114

(57) ABSTRACT

Methods, systems and computer program products display data in a selected language. A data record formatted in a language independent markup format is received and a style sheet associated with the selected language is retrieved. The data record is formatted based on the style sheet and the formatted data record is displayed in the selected language. Data may be generated at a first data processing system that displays text in a first language and provided to a second data processing system that displays text in a second language different from the first language by generating data values at the first data processing system and incorporating the generated data values in a language independent markup document. The language independent markup document may include an identification of a style sheet that specifies how to present the data values in the second language to provide the data record.

### BACKGROUND OF THE INVENTION

The present invention, generally, relates to data communication methods, systems and computer program products and, more particularly, to methods, systems and computer program products for the display of communicated data.

Companies are often dependent on mission-critical network applications to stay productive and competitive. Typical computer networks supporting such applications may be either based on a host processor device and various connected user access terminals or a client-server type network, in which server devices are accessed by users using client devices. Information is generally displayed at the user devices using output devices such as video display terminals, printers and the like. Information may be transferred between devices for display by the receiving device. In addition, locally generated information may be displayed on the display terminal. Information to be displayed may be a composition of system-provided words or phrases followed by user or system-supplied data fields, which may be displayed in a predetermined pattern on a screen.

For some applications, a limited number of screen patterns or formats are provided so that only a standard set of screen images corresponding to the formats are used for display. The definition of each screen format is typically deeply embedded in the source code for the application. The application source codes in cooperation with the operating system then define and generate the display. As such, there is typically very little flexibility provided to the user to allow for the creation of customized formats and, correspondingly, their screen images.

A client-server type network is illustrated by the Internet, where clients (browsers) communicate with Internet servers. To provide greater access to the Internet the communication protocols and languages utilized by the clients and servers have become standardized. These protocols include the Hyper-Text Transfer Protocol (HTTP), which is the communication protocol used for communications between clients and servers, and the Transfer Control Protocol/Internet Protocol (TCP/IP), the TCP portion of which is the transport specific protocol for communication between computers or applications. Also standardized is the language in which clients and servers communicate, which is called Hyper-Text Markup Language (HTML). Because these protocols and language are machine independent, and utilize a state-less best-efforts protocol for sending information, each transaction is generally fully self contained. Similar protocols are typically utilized on company intranets to allow for the appearance to a user of seamless communications within the intranet and/or over the Internet.

In the context of World Wide Web client/server applications, the client may be a web browser that acts as the user interface. The web browser sends user requests to the appropriate web server and formats and displays the HTML data returned from the web server (although formatting may occur at the server). The web browser also evaluates the HTML data to determine if there are any embedded hyper-link statements in the HTML data that would require subsequent browser requests to be initiated by the browser. A web server acts as the server for the client and processes the web browser's requests and returns the requested response as an HTML data portion of a HTTP data stream.

A further format for web based communications of structured documents and data is the Extensible Markup Language (XML). While HTML was designed to display data and focuses on what the display of the data looks like, XML was designed to describe data. Thus, an XML file is generally intended to describe information, not to display the information, and uses tags to “wrap” the information (i.e., markup the information by positioning different pieces of information between tags). In other words, XML is a cross-platform tool for transmitting information that may then be displayed, for example, by HTML.

As the tags of XML are generally not predefined, the eXtensible Stylesheet Language (XSL) is available to provide HTML style information for use in displaying XML files. XSL is a language that can be used, among other things, to transform XML into HTML, to filter and sort XML data, to define parts of an XML document and/or to format XML data based on the data value, for example, providing a different color for negative numbers.

To expand the user base of already developed software application systems, in particular, to allow foreign affiliates of the system developer full utilization of system capabilities, modifications to the source code of the system have generally been required. For example, rewriting significant portions of the code implementing input/output (I/O) interface functions may be necessary to provide foreign affiliates with a different language from that of the system developer to facilitate full use of the system capabilities. Furthermore, as each language version of the code is a different executable version of the code (referred to herein as a “binary” or “binaries”), multiple binaries, typically one for each different language location, may be required and each may need to be separately quality tested. Development costs for new applications and updates to existing applications may also be higher as additional programming resources may be used.

Alternatively, a Unicode binary version of the code may be provided for all language locations. Unicode typically displays multiple languages simultaneously. However, viewers that do not understand all of the languages will not be able to understand portions of the display.

In addition to the problem of direct language translation, there may also be problems in handling the data supplied to the data fields associated with the use of the application in different countries. For example, it may be necessary to convert some data, such as by converting from a non-metric to a metric system of units. Other data may need to be re-ordered, such as month/day/year versus day/month/year.

One approach to the language related display problem is described in U.S. Pat. No. 4,870,610 to Belfer. The '610 patent proposes the use of an autonomous language translator interposed between a host and a user access device that translates a received screen from a source device language to a second language counterpart before it is provided to the destination access device. Thus, the translation device is provided translation files in lieu of modifying the application's underlying source code.

### SUMMARY OF THE INVENTION

Embodiments of the present invention provide for displaying data in a selected language. A data record formatted in a language independent markup format is received. A style sheet associated with the selected language is retrieved. The data record is formatted based on the style sheet and displayed in the selected language.

In other embodiments of the present invention, retrieving a style sheet further includes retrieving a second style sheet associated with a second language different from the selected language. Formatting the data record further includes formatting the data record based on the second style sheet and displaying the data record further includes displaying the data record formatted based on the second style sheet in the second language. Receiving the data record need not require that the data record be from a remote device and, instead, may simply include retrieving the data record from storage. A plurality of style sheets associated with different languages may be provided and the plurality of style sheets may include a locale attribute specifying an associated one of the different languages.

In further embodiments of the present invention, the data record includes data collected at a remote location that displays data using a second language different from the selected language. The style sheet may contain a plurality of text records in the selected language and the data record may contain a plurality of data values in a language independent/neutral format. The data record may be an extensible markup language (XML) file and the style sheet may be an extensible stylesheet language (XSL) file. Formatting the data record may include interspersing the text records with the data values based on the style sheet to provide the formatted data record. Interspersing the text records with the data values may include interspersing the text records with the data values based on tags associated with the data values in the data record.

In other embodiments of the present invention, the data record includes network resource utilization and/or event indicator data collected by an application manager agent at the remote location. The data record may have an associated message type selected from a plurality of message types each having an associated style sheet and retrieving a style sheet may include retrieving a style sheet associated with the message type of the data record. The data record may include data collected by one of a plurality of application manager agents and ones of the plurality of application manager agents may have associated message types.

The data values may be numerical values and/or event indicators. The data record may include tabular data and formatting the data record may include sorting the tabular data for display.

In further embodiments of the present invention, receiving, retrieving, formatting and displaying are performed by a first application program. In such embodiments, the formatted data record may be provided to another application program for further processing. The other application program may be, for example, a system management program.

In other embodiments of the present invention, the received data record includes a schema defining data and a style sheet identifier and the style sheet is retrieved based on the style sheet identifier and the data record is formatted based on the style sheet and the schema. The schema may further include display information in a base language and a default style sheet configured to display data in the base language using a default format may be retrieved if the style sheet identifier corresponds to an invalid style sheet at a data processing system receiving the data record. The formatted data record may then be displayed in the base language and the default format. The data record may include a plurality of style sheet identifiers that may be all be associated with a single style sheet or may be associated with different style sheets.

In some embodiments of the present invention, the retrieved style sheet includes a plurality of data descriptions that specify descriptions for ones of the data values. The retrieved style sheet may also include at least one unit specification that specifies a language specific unit for at least one of the data values. The retrieved style sheet may further specify a free format table. The data record may include a date value and/or a time value in a predefined format and the retrieved style sheet may specify a display format for date and/or time value associated with the selected language. The style sheet may specify a run time dynamically determined display format, for example, matching the display system's format, or a predetermined format for the date and/or time value.

In further embodiments of the present invention, the data record is a collaborative editing document (e.g., more than one user may modify the data).

In other embodiments of the present invention, the data record and data values are generated. The generated data values are presented in a language independent markup format to provide the data record. The data record is forwarded from the remote location to a location using the selected language for display in the selected language.

In further embodiments of the present invention, data generated at a first data processing system that displays text in a first language is provided to a second data processing system that displays text in a second language different from the first language. Data values are generated at the first data processing system. The generated data values are incorporated in a language independent markup document. The language independent markup document includes an identification of a style sheet that specifies how to present the data values in the second language. The resulting data record is forwarded from the first data processing system to the second data processing system.

In other embodiments of the present invention, language independent display of data is provided by a data generation module at a first data processing system that displays text in a first language. The data generation module is configured to generate data values and incorporate the generated data values in a language independent markup document including an identification of a style sheet that specifies how to display text associated with the data values in a second language different from the first language. The data generation module is further configured to forward the data record from the first data processing system to a second data processing system that displays text in the second language. The data generation module may be a language independent binary.

In further embodiments of the present invention, a data display module is configured to receive a data record formatted in a language independent markup format from a data processing system that displays text in a language different from the first language and to retrieve a style sheet that specifies how to display text associated with the data values in the data record in the first language. The data display module is further configured to format the data record based on the retrieved style sheet and display the formatted data values in the first language. At least one style sheet is provided that is associated with the first language. The data display module may be a language independent binary. The language for display may be, for example, English, German, French, Spanish, Chinese and/or Japanese.

In other embodiments of the present invention, a plurality of style sheets are associated with ones of a plurality of different message types. The data generation module is configured to incorporate generated data values associated with a selected one of the message types in a language independent markup document including an identification of a style sheet associated with the selected one of the message types. The data generation module may be a system management module that generates data values that are numerical values and/or event indicators. The data generation module may be a plurality of data acquisition agent scripts, a first one of the data acquisition agent scripts being associated with a first one of the message types and a second one of the data acquisition agent scripts being associated with a second one of the message types. A plurality of data generation modules resident on managed application servers that are configured to gather data from a managed application server on which they reside may be provided.

In further embodiments of the present invention, language independent display of data in a first language is provided by a data display module configured to receive a data record formatted in a language independent markup format from a data processing system that displays text in a language different from the first language and to retrieve a style sheet that specifies how to display text associated with the data values in the data record in the first language. The data display module is further configured to format the data record based on the retrieved style sheet and to display the formatted data values in the first language. At least one style sheet associated with the first language is provided.

In other embodiments of the present invention, methods for displaying data in a dynamically defined format include receiving a data record formatted in a markup format and including a schema and a style sheet identifier. A style sheet is retrieved based on the style sheet identifier. The data record is formatted based on the received schema and the retrieved style sheet to provide the dynamically defined format for display and the formatted data record is displayed in the dynamically defined format.

In some embodiments of the present invention, the schema includes display information in a base language and the style sheet identifier is an identifier associated with a default style sheet configured to display data for a plurality of schema. The formatted data record is displayed in the base language. The data record may be formatted in a language independent markup format and the style sheet identifier may be an identifier of a style sheet associated with a selected language. The formatted data record may be displayed in the selected language. The style sheet identifier may identify an unavailable style sheet and formatting the data may include formatting the data record based on a default style sheet.

In further embodiments of the present invention, the data record includes a plurality of style sheet identifiers. The plurality of style sheet identifiers may all be associated with a single style sheet and/or at least one of the plurality of style sheet identifiers may be associated with a different style sheet than another of the plurality of style sheet identifiers and a plurality of style sheets may be retrieved to format the received data record for display.

In other embodiments of the present invention, methods for providing data configured for display in a dynamically defined format include generating data values at a first data processing system. The generated data values are incorporated in a markup format document. A schema is incorporated in the markup format document that defines a data display format. A style sheet identifier is also incorporated in the markup format document that identifies a style sheet that specifies how to format the generated data values for display using the schema. The markup format document is forwarded from the first data processing system to a second data processing system for display in the dynamically defined format.

In further embodiments of the present invention, systems for displaying data in a dynamically defined format include a data display module and at least one style sheet identified by a style sheet identifier. The data display module is configured to receive a data record formatted in a markup format and including a schema and a style sheet identifier and to retrieve a style sheet based on the style sheet identifier. The data display module is also configured to format the data record based on the received schema and the retrieved style sheet to provide the dynamically defined format for display and to display the formatted data record in the dynamically defined format.

While described above primarily with reference to methods, systems and computer program products are also provided in accordance with further embodiments of the present invention.

### BRIEF DESCRIPTION OF THE DRAWINGS

FIG. 1 is a block diagram of a hardware and software environment in which the present invention may operate according to some embodiments of the present invention;

FIG. 2 is a block diagram of a data processing system according to some embodiments of the present invention;

FIG. 3 is a more detailed block diagram of a data processing system implementing a control and/or an endpoint node according to some embodiments of the present invention;

FIG. 4 is a flow chart illustrating operations for displaying data in a selected language according to some embodiments of the present invention;

FIG. 5 is a flow chart illustrating operations for generating data for display according to some embodiments of the present invention;

FIG. 6 is a block diagram illustrating an application management system providing language independent display of data according to some embodiments of the present invention;

FIG. 7 is a block diagram illustrating exemplary operations of an application management system providing language independent display of data according to some embodiments of the present invention;

FIGS. 8A-8B illustrate exemplary screen displays in different languages according to some embodiments of the present invention;

FIGS. 9A-9C illustrate exemplary screen displays including a table in different languages according to some embodiments of the present invention;

FIGS. 10A-10E illustrate exemplary XML, XSL and HTML for the screen displays of FIGS. 8A-8B;

FIGS. 11A-11G illustrate exemplary XML, XSL and HTML for the screen displays of FIGS. 9A-9C; and

FIG. 12 illustrates an example XML data record according to some embodiments of the present invention.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by one of skill in the art, the present invention may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer usable storage medium having computer-usable program code means embodied in the medium. Any suitable locally or remotely computer readable medium may be used including hard disks, CD-ROMs, optical storage devices, a transmission media such as those supporting the Internet or an intranet, or magnetic storage devices.

Computer program code for carrying out operations of the present invention may be written in an object oriented programming language, such as Java® or C++ or C#. However, the computer program code for carrying out operations of the present invention may also be written in conventional procedural programming languages, such as the “C” programming language or assembly language. The program code may execute entirely on the user's computer, partly on the user's computer, as a stand alone software package, partly on the user's computer and partly on a remote computer, or entirely on the remote computer. In the latter scenario, the remote computer may be connected to the user's computer through a local area network (LAN) or a wide area network (WAN).

The present invention is described below with reference to flowchart illustrations and/or block diagrams of methods, apparatus (systems) and computer program products according to some embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified in the flowchart and/or block diagram block or blocks.

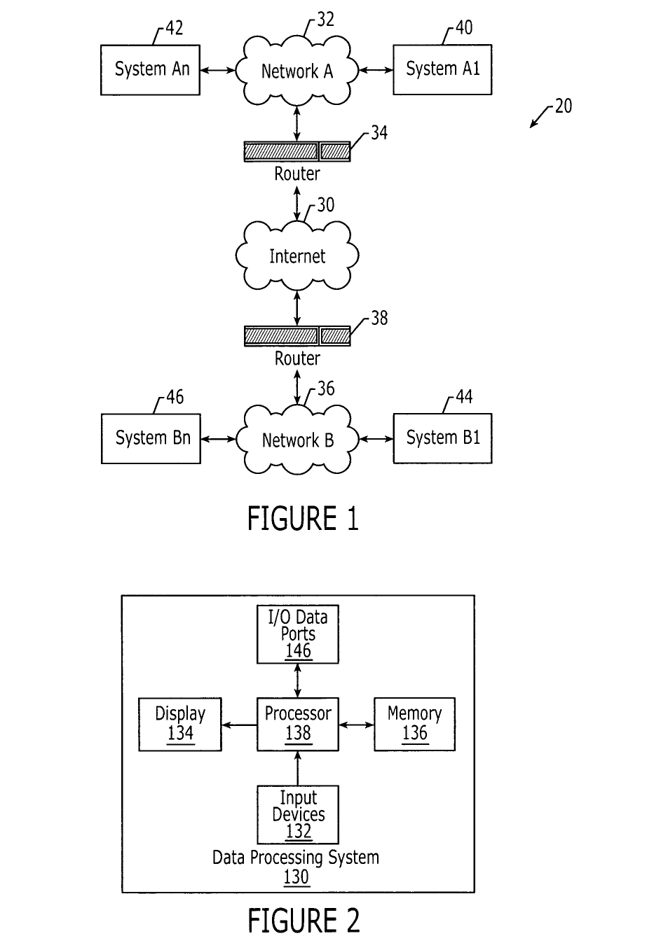

Embodiments of the present invention will now be described with respect to the figures. Embodiments of the present invention provide methods, systems and/or computer program products for generation and/or display of data in a selected language. Referring first to FIG. 1, a hardware and software environment in which the present invention can operate will be described. The network 20 provides a communication link between a series of data processing (computer) systems 40, 42, 44, 46 that may operate as clients and/or servers configured to generate and or display data in accordance with embodiments of the present invention.

As will be understood by those having skill in the art, a network 20 may include a plurality of separate linked physical communication networks, which, using a protocol such as the Internet protocol (IP), may appear to be a single seamless communications network to user application programs. For example, as illustrated in FIG. 1, the network 32 and the network 36 may be local networks or intranets coupled to each other over the Internet network 30 via the respective routers 34, 38. It is further to be understood that, while for illustration purposes in FIG. 1 the communication networks 30, 32, 36 are each shown as a single network, they may be comprised of a plurality of separate interconnected physical networks.

FIG. 2 illustrates an exemplary embodiment of a data processing system 130 suitable for use in accordance with embodiments of the present invention. The data processing system 130 typically includes input device(s) 132 such as a keyboard or keypad, a display 134, and a memory 136 that communicate with a processor 138. The data processing system 130 may further include an I/O data port(s) 146 that also communicate with the processor 138. The I/O data ports 146 can be used to transfer information between the data processing system 130 and another computer system or a network, such as the network 20 of FIG. 1. These components may be conventional components, such as those used in many conventional data processing systems, which may be configured to operate as described herein.

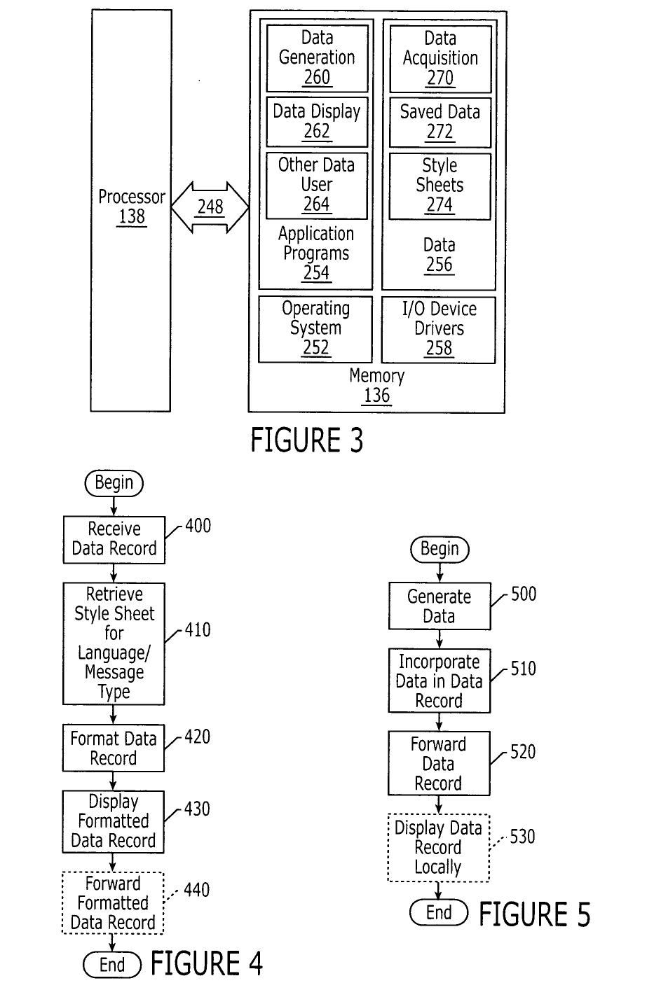

FIG. 3 is a block diagram of a data processing (computer) system that further illustrates systems, methods, and computer program products in accordance with embodiments of the present invention. The processor 138 communicates with the memory 136 via an address/data bus 248. The processor 138 can be any commercially available or custom microprocessor. The memory 136 is representative of the overall hierarchy of memory devices containing the software and data used to implement the functionality of the data processing system 130. The memory 136 can include, but is not limited to, the following types of devices: cache, ROM, PROM, EPROM, EEPROM, flash memory, SRAM, and DRAM.

As shown in FIG. 3, the memory 136 may include several categories of software and data used in the data processing system 130: the operating system 252; the application programs 254; the input/output (I/O) device drivers 258; and the data 256. As will be appreciated by those of skill in the art, the operating system 252 may be any operating system suitable for use with a data processing system, such as Solaris from Sun Microsystems, OS/2, AIX or System390 from International Business Machines Corporation, Armonk, N.Y., Windows95, Windows98, Windows NT, Windows ME, Windows XP, Windows 2000 or Windows 2003 from Microsoft Corporation, Redmond, Wash., Unix or Linux. The I/O device drivers 258 typically include software routines accessed through the operating system 252 by the application programs 254 to communicate with devices such as the I/O data port(s) 146 and certain memory 136 components. The application programs 254 are illustrative of the programs that implement the various features of the data processing system 130 and preferably include at least one application that supports operations according to embodiments of the present invention. Finally, the data 256 represents the static and dynamic data used by the application programs 254, the operating system 252, the I/O device drivers 258, and other software programs that may reside in the memory 136.

As is further seen in FIG. 3, the application programs 254 may include a data generation module 260, a data display module 262 and one or more other data user application 264 that may utilize received data as formatted in accordance with embodiments of the present invention.

The data generation module 260 may be an application manager program in certain embodiments, for example, the AppManager™ product available from NetIQ Corporation or other application program in which it is desirable to provide the ability to communicate in different languages. The other data user application 264 may be a system manager application, for example, the Microsoft Operations Manager (MOM) available from Microsoft Corporation, or other application using data formatted by some embodiments of the present invention.

The data portion 256 of memory 136, as shown in the embodiments of FIG. 3, may include data acquisition data (i.e., information associated with generating data) 270, saved data 272 and/or style sheets 274. The data acquisition data 270 may provide, for example, information related to identifying, addressing and collecting data from different network resources such as applications, printers and the like. The saved data 272 may be provided where the underlying application generating data for display in a selected language stores acquired data for some selected period of time. The style sheet(s) 274 may include display formatting information for one or more different languages for one or more message types of received data records.

In various embodiments of the present invention, the data generation module 260 may be associated with a first data processing system that displays text in a first language. For example, the first language could be English. In such embodiments, the data generation module 260 may be configured to carry out a variety of operations related to generating a data record in a language independent format that may then be provided to a second data processing system where it is desired to display the data in a different language, which different language may or may not be known by the data generation module 260 at the time the data is generated.

While the data record is referred to herein as being in a language independent markup format, it is to be understood that the language independent markup format refers to the formatting of the data in a data record and that additional information may be included in the data record that is not language independent. For example, some information included in the data record may be in a base language, such as in English. Furthermore, as will be described more fully later herein, in some embodiments of the present invention providing dynamic schema, the markup format for the data provided by the data generation module 260 need not be language independent.

The data generation module 260 is configured to generate the underlying data values. The data generation module 260 may generate data values by gathering the data itself or receiving the data from the other data user application 264 or from applications executing on different data processing systems operatively coupled to the data generation module 260. The data generation module 260 in such embodiments is further configured to incorporate the generated data values in a language independent markup format document, such as an XML file including language independent/neutral format data values.

An identification of a style sheet that specifies how to display text associated with the data values in a second language different from the first language is included in the language independent markup format document. The identification of the style sheet may itself not be unique to a specific language and may be associated with a particular message type having recurring data values associated with the message type. Thus, a receiving data processing system in Japan may retrieve the identification of the style sheet and use an associated style sheet based on that identification that generates Japanese characters for display text. A receiving data processing system in Germany could use the same identification value of a style sheet in the language independent markup format document to retrieve a style sheet providing for display of text in German.

Furthermore, while described with reference to a single data sheet for a language for a message type, various embodiments of the present invention include more than one style sheet for a language for some message types. For example, a text only style sheet and another with graphical representation information.

In addition, while embodiments of the present invention have generally been described above with reference to a style sheet being associated with a single identifier and a received data record including a single style sheet identifier, it is to be understood that a single style sheet may include formatting information associated with a plurality of different identifiers. Similarly, a received data record may include a plurality of style sheet identifiers to be used in formatting the data in the data record for display. All of the identifiers in a received data record may be associated with a single style sheet or may be associated with different style sheets, in which case multiple style sheets may be retrieved to format the data for display. Also, a default style sheet in a base language and using a default display format may be provided and, if a style sheet identified in a received data record is invalid and/or not available at a receiving data processing system, the default style sheet may be retrieved and the data may be formatted for display in the base language and the default format.

The data generation module 260 may further be configured to forward the data record from the first data processing system to a second data processing system that displays text in the second language. For example, the data generation module 260 may be configured to interface with the I/O device drivers 258 and output data through the I/O data ports 146 (FIG. 2) over the internet network 30 of FIG. 1.

The data display module 262 may be configured to receive a data record formatted in a language independent markup format from a data processing system that displays text and language different from the first language, such as English, associated with the data processing system on which the data display module 262 is running. The data display module 262 may further be configured to retrieve a style sheet that specifies how to display text associated with data values in the received data record in the first language. The data display module 262 may then format the data record based on the retrieved style sheet and display the formatted data values, for example, on the display 134 (FIG. 2).

In further embodiments of the present invention, the data record is simply a record at the data processing system including the data display module 262. As such the data record is received by retrieving it from local storage. The data display module 262 may be configured to display the data record locally in a plurality of languages having associated style sheets accessible to the data display module 262. For example, different local applications may display data (generated elsewhere or locally) in different languages. Furthermore, a particular data processing system according to some embodiments of the present invention may only include a data generation module 260 or may only include a data display module 262.

The data generation module 260 may be provided as a language independent binary application so that a single binary may be utilized in many different countries or to provide a flexible language display selection for individual devices located within a country. Use of such a language independent binary may beneficially reduce the software development cost and testing cycle for introduction of new applications and/or updates of existing applications. The data display module 262 may also be a language independent binary application.

As noted above, the style sheets 274 may each be associated with one of a plurality of different message types and different style sheets may be provided for each message type for each language that it may be desired to display text in on the data processing system 130 (FIG. 2). Thus, embodiments of the present invention may provide an integrated network supporting users communicating in a variety of different languages or provide flexible language display at a local station of a network to support display of text with integrated data that may be gathered at remote locations using an indeterminate language (such as German, French, Spanish, Chinese, Japanese, and so on) while still utilizing a single binary for generation and display of the data in the selected text. Various embodiments of the systems of the present invention will be further described herein with particular reference to an exemplary application in connection with a system or application management environment.

While the present invention is illustrated, for example, with reference to the data generation module 260 being an application program in FIG. 3, as will be appreciated by those of skill in the art, other configurations may also be utilized while still benefiting from the teachings of the present invention. For example, the data generation module 260 may also be incorporated into the operating system 252 or other such logical division of the data processing system 130. Thus, the present invention should not be construed as limited to the configuration of FIG. 3 but is intended to encompass any configuration capable of carrying out the operations described herein.

Furthermore, while each of the data generation module 260, the data display module 262 and the other data user application 264 are illustrated in a single data processing system, as will be appreciated by those of skill in the art, such functionality may be distributed across one or more data processing systems. For example, the functionality of the data generation module 260 may be provided on one or more data processing (computer) systems that are separate from the data processing system that provides the functionality of the data display module 262. Thus, the present invention should not be construed as limited to the configuration illustrated in FIGS. 2-3 but may be provided by other arrangements and/or division of function between data processing systems.

Referring now to the flowchart diagram of FIG. 4, operations for displaying data in a selected language according to embodiments of the present invention begin at Block 400 when a data record is received, for example, from the remote location, that is formatted in a language independent markup format. A style sheet associated with the selected language for display at the receiving data processing system is retrieved, for example, from the stored style sheets 274 (FIG. 3) or, in some embodiments, from the data record received at Block 400 where the style sheet is included with the data record (Block 410). In various embodiments of the present invention, the received data record has an associated message type selected from a plurality of different message types. For example, message types distinguishing the type of data values included in the data records. In such embodiments of the present invention, retrieving a style sheet at Block 410 may include retrieving a style sheet associated with the message type of the received data record. As such, the received data record may be data collected at a remote location that displays data using a language different from the selected language for the receiving data processing system and the style sheet retrieved in Block 410 may include in its formatting information one or more text records in the selected language of the receiving data processing system.

The data record is formatted for display based on the retrieved style sheet (Block 420). For example, formatting operations at Block 420 may include interspersing text records in a selected language from the retrieved style sheet with data values from the received data record based on formatting information from the retrieved style sheet. Among other things, the text records from the style sheet may be interspersed with the data values to provide a formatted screen display to a user, such as a graphic user interface (GUI). The language independent neutral markup format of the received data record may use tagged data values and the text records may be interspersed with the data values based on the tags associated with the data values in the data record as will be further illustrated by the exemplary embodiments related to application management discussed herein. The formatted data record may then be displayed to a user (Block 430).

In some embodiments of the present invention the data records received at Block 400 may be extensible markup language (XML) files including language independent/neutral format data values. Furthermore, the style sheet received at Block 410 may be an eXtensible Stylesheet Language (XSL) based style sheet. The received data record may also include tabular data and formatting operations at Block 420 may include sorting the tabular data for display, for example, using dynamic HTML (DHTML).

In various embodiments of the present invention, operations may further include providing the formatted data record from Block 420 to another application program for further processing (Block 440). The other application program may, for example, be an operation manager program, such as Microsoft Operations Manager (MOM).

The text records in the retrieved style sheet in the selected language may be, for example, a plurality of data descriptions that specify text language descriptions for various ones of the data values in the received data record. The style sheets may further include a unit specification for one or more of the data values that specifies a language specific unit for the data value(s) and may further specify a pre-format table for display of one or more of the data values. Operations at block 410 require that the style sheet be accessible to the data processing system displaying data in the selected language. For example, the style sheet may be maintained locally in a database on a local storage device. Alternatively, the storage device containing the style sheet may be located remotely and accessed by the data processing system, for example, over the network 30, 32, 36. The style sheet database may be specific to a language and/or data processing system or may be a centralized database accessed by a number of different data processing systems that may display formatted data in a number of different languages. In some embodiments of the present invention, the style sheet is provided with the data record and retrieving the style sheet includes retrieving the style sheet from the data record.

In various embodiments of the present invention, means are further provided for identifying and acquiring new style sheets and adding to the database of style sheets. For example, the unique identifier in the received record may provide an index to a provider that maintains and updates style sheets for a variety of message types associated with different data generation applications and a variety of different languages. New application programmers could then provide any required style sheets to the provider for distribution on demand or at the time of registration to various end users. Alternatively, the received data record could include both an identifier of a style sheet and information related to obtaining the style sheet, such as an IP address and/or URL of the application programmer that generated the message type and associated style sheet. Different application programmers could then support the style sheets for their own applications of the present invention and the data generation and/or display modules 260, 262 could be further configured to determine the address and obtain the style sheet from the application programmer.

Similarly, application programmers may wish to vary the language independent/neutral format for data values in a particular message type. For example, they may wish to add a new data format for a distinct type of data values. As with style sheets, it is to be understood that such format information may be maintained at a data processing system receiving the data record, at a central repository accessible to the data processing system, on request from a provider, who may be the same as the provider for style sheets, and/or by accessing a specific application program to obtain the format information, such as at an IP address included in the data message. Accordingly, such address fields for accessing providers may be provided at a predefined location in the data records and the address may be set to a null value when the format and style sheet are otherwise already available to the data processing system.

Operations related to providing data generated on a first data processing system that displays text in a first language to a second data processing system that displays text in a second language different from the first language will now be described with reference to the embodiments of the present invention illustrated in FIG. 5. As illustrated in FIG. 5, operations begin at Block 500 with the first data processing system generating data values. The data values may be, for example, numerical values and/or event indicators. In some embodiments of the present invention, the numerical values relate to network resource utilization, performance, availability, configuration, security and/or systems information. The network resource may be, for example, data processing systems, applications and/or network resources. The data may include a variety of different formats of data such as date values, time values, strings, text characters, integer number, floating point numbers and/or currency. In alternative embodiments, the data values may be associated with a collaborative editing document that is being edited by multiple editors using different languages.

The generated data values are incorporated in a language independent markup document, such as an XML file (Block 510). The language independent markup document may include an identification of a style sheet that specifies how to present the data values in a different language. The data record may then be forwarded from the first data processing system to another data processing system using a different language for display of text (Block 520). In various embodiments of the present invention, the data may also (or instead) be displayed locally (Block 530). As a language independent/neutral markup format is used for the data values, format and operations for local display may proceed substantially as described with reference to Blocks 410-430 of FIG. 4.

The language independent/neutral format of the data values may vary based on the application generating the data. An exemplary language independent/neutral format may include some and/or all of the following specified formats:

For this example, in addition to the format information below, the same decimal point (“.”), the same grouping separator (“,”), the same date/time format and so on may be used. The scope of neutral format includes:

Date: formatted as “YYYY/MM/DD”;

Time: formatted as “HH:MM:SS” in 24 hour format (i.e., no AM or PM is needed);

Datetime: formatted as “YYYY/MM/DD HH:MM:SS” in 24 hour format in GMT;

String: formatted as % s (with proper encoding (in a character encoding system that can support multiple languages, such as Unicode) on different platforms);

Character: formatted as % c (in proper encoding (in a character encoding system that can support multiple languages, such as Unicode) on different platforms);

Long: formatted as % Id;

Integer: formatted as % d; and

Float/Double: formatted as %.2f (two digits after the decimal point).

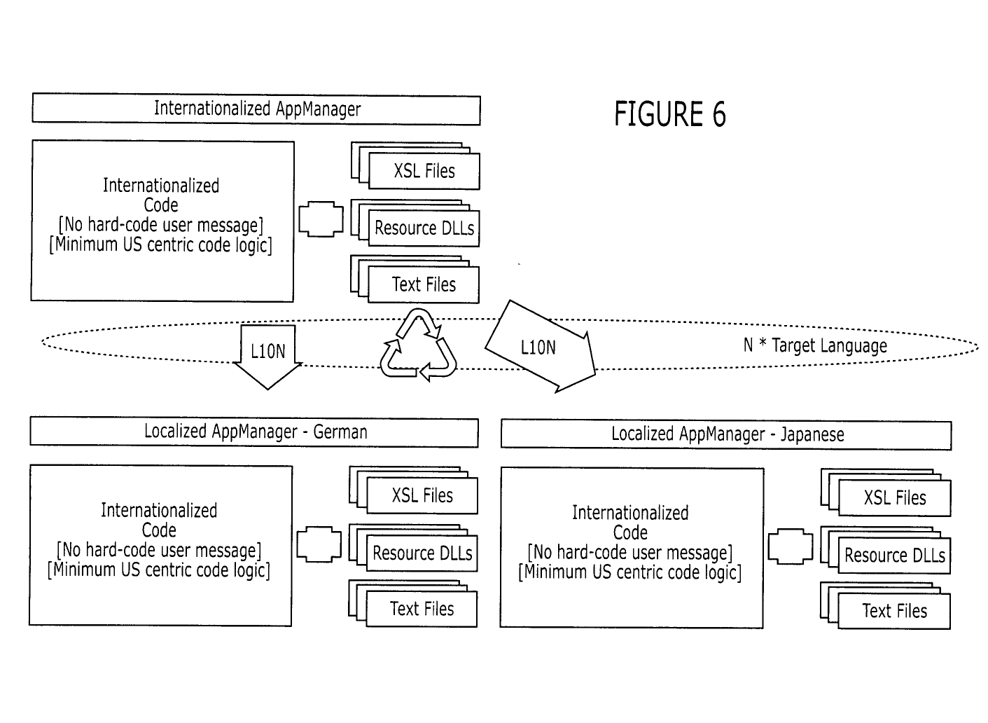

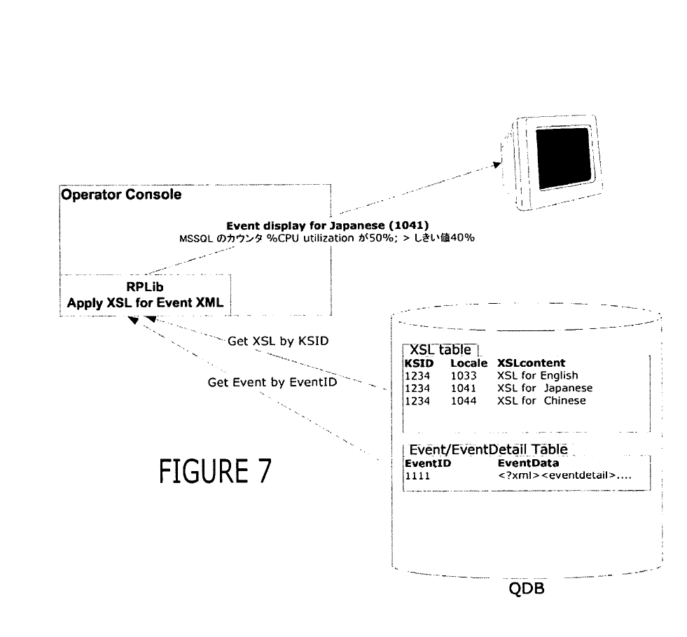

Particular embodiments of the systems of the present invention will now be further described with reference to the block diagrams of FIGS. 6 and 7 that illustrate embodiments of the present invention in connection with an application manager product. Such an application management environment may be particularly beneficial for an international corporation where gathered application management data is collected and associated with different languages in different countries while a corporate network manager may wish to view, in a single language, information regarding application and resource utilization in multiple countries. In such a context, it may be desirable to provide for display of information both in the local language in the country in which it is collected as well as in the language of other countries that are included in the system.

As illustrated in FIG. 6, an internationalized AppManager® is provided using an internationalized binary that is independent from a particular language. The central, or English language location, may include XSL files, common resource DLLs and text files based on the English language. The centralized location may further maintain style sheets as XSL files and may also utilize resource DLLs and text files supporting other languages if it is desired to have multiple language display capability at the main location.

The internationalized binary may be used without revision to provide a localized AppManager® in German and Japanese respectively as illustrated in FIG. 6. The different language presentation display is provided through distinct XSL files, resource DLLs and/or text files in each of the respective locations complimenting the common internationalized binary. Thus, with the system of FIG. 6, data may be gathered and sent back to a central repository as structured data without being pre-formatted in a manner that would cause language dependency. The schema of the data and information on how to display the data may be maintained in a storage device or data base accessible to the various locations as needed. At display time, the format information is used to display the structured data in the format and language that is desired by the user requesting the display. As noted previously, XML may be used for describing the structured data and XSL may be used to provide format information on how to display the data.

It will be understood that in the case of an application management software product such as AppManager®, agents (represented as internationalized code in FIG. 6) may be installed on most of the managed application servers in each of the respective locales. The agents may gather data from those servers without pre-formatting so that the generated data from each location will not be language (locale) specific. User interface code for accessing the data at the various locations, such as a user console application or a report writing application, may then display data in a desired language and or style (i.e., tabular, graph, etc.). As a further potential advantage of the configuration illustrated in FIG. 6, a single centralized database, such as an SQL server based database (QDB), may be configured to support data values collected across a variety of locales rather than requiring a distinct and separate central repository for different collected data, which may be required if the data is formatted to a particular language.

Generally, an AppManager® application of the present invention will generate a variety of different data values either representing resource utilization, status, etc., or event indicators indicating an event occurring on a network resource, such as a violation of a threshold established by a network administrator. Thus, the internationalized code may include a variety of data collection scripts (agents) associated with different data values. The data values for each data collection script may be organized as a message type and a variety of different message types may be specified for the application manager software. Separate style sheets may be provided for each message type (and each language for each message type) to ensure flexibility in the types of data values that may be displayed in a selected language in accordance with various embodiments of the present invention. Furthermore, the flexibility of configuring the data for display at run time may allow for options such as sorting of tables and the like at display time.

As shown in FIG. 6, the program may also utilize resource DLLs provided at a local location or text files. The DLLs may be used, for example, to display information in a local language that is not directly related to the display or formatting of the received data in accordance with embodiments of the present invention. For example, a browser interface used for display of the formatted data may have help and/or shortcut windows accessed by selecting the right mouse button or a tool bar icon associated with a pull-down/pop-up menu. The local DLLs may be used to provide the necessary characters for display of such information in the local language.

Access and display of the information for an application manager is further illustrated in FIG. 7. As shown in FIG. 7, the operator console accesses data in the QDB database. The QDB database includes an XSL table including a plurality of style sheets. As shown in the XSL table in FIG. 7, XSL style sheets are provided for a particular type of data collecting message script, identified as KSID number 1234, in English (Locale 1033), Japanese (Locale 1041), and Chinese (Locale 1044). Also shown in FIG. 7 is a markup format (XML) event data record (Event ID 1111).

A user of the operator console may initiate execution of the “RPLib” application to retrieve the event data record and associated XSL based style sheet by KSID and desired locale ID. Then, RPLib applies XSL to the XML to generate human readable data in a desired language. “RPLib” refers to a database access layer of the operator console and need not be limited to any particular database access application. Thus, the actual character strings presented to a user and/or graphical display information may be presented in the language that the user understands regardless of the location of the agent application that generated the data.

The actual build/display application for developing the output display information may be a browser application generating the HTML output for display. It is to be understood that, while the display is indicated in FIG. 7 as going to a CRT or flat screen monitor, display as used herein may also refer to output formatted for transmission to other output devices, such as printers, or for output to a file format for storage.

In further aspects of the present invention, a schema may be used with the script file to provide for pre-declared schemas that are statistically known beforehand and provide for display of data at the receiving data processing system. Utilizing a schema block may reduce the size of messages sent by the data generating application and may facilitate creation of reports based on the pre-declared schema without relying on actual data. A schema generally will be associated with a table or other format for presentation of data and may specify information such as headers, column and row information and data type used in formatting received data for display. Schema are preferably unique and may have a unique ID or universal unique identifier (UUID) that may be included in the language independent markup format data record as transmitted from a data value generating device to a display device. The use of a UUID may facilitate reliable exchange of data for display between locations.

In particular embodiments of the present invention, schema are also provided for display of data in a dynamically defined format. As used herein, a “schema” is a definition of variables used in formatting data for display. The schema may also include information such as a text description of a variable in a base language for display where a language specific style sheet is not present at the receiving data processing system that is displaying data from a received markup format data record. The schema may also include additional display information such as a table format or other relation between the variables defined by the schema.

The schema of the present invention differ from the approach, for example, of the MicroSoft Management Instrumentation (WMI) or the common information management (CIM) format. WMI and CIM have some similarities in their establishing a relationship between objects set up in advance and saved in a database available to applications executing at a local data processing system to provide a relationship between, for example, columns and a data type. In contrast, for some embodiments of the present invention, the provided schema can provide for dynamic formatting of data for display by including the schema in the markup format data record at the time it is provided to the data processing system for display. Thus, dynamic schema may be defined/re-defined at run time by sending the schema itself to the receiving data processing system. In contrast WMI generally registers schema at install time rather than creating/modifying the schema at run time. Types in WMI schema also can be generally derived from existing types while the types of the present invention are generally not derived from existing types when using schema to provide for display of data in a dynamically defined format.

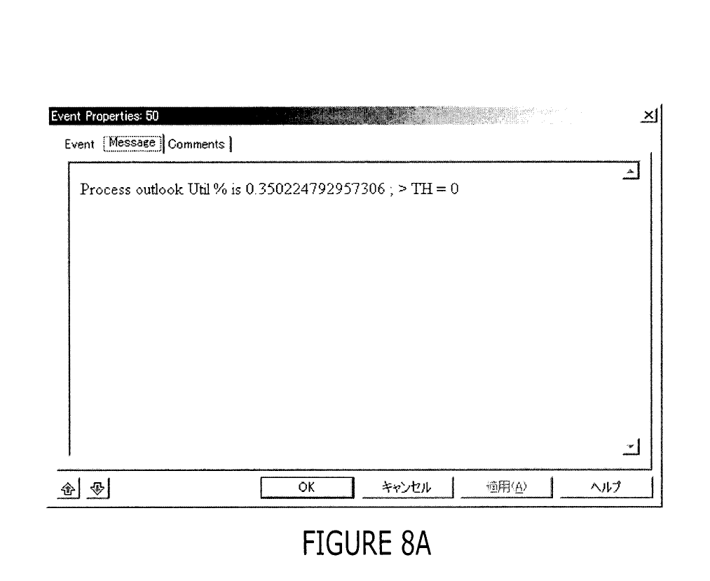

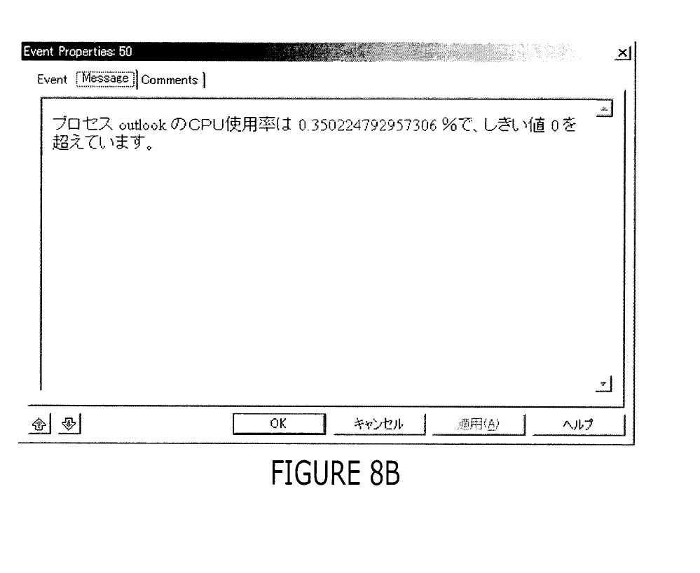

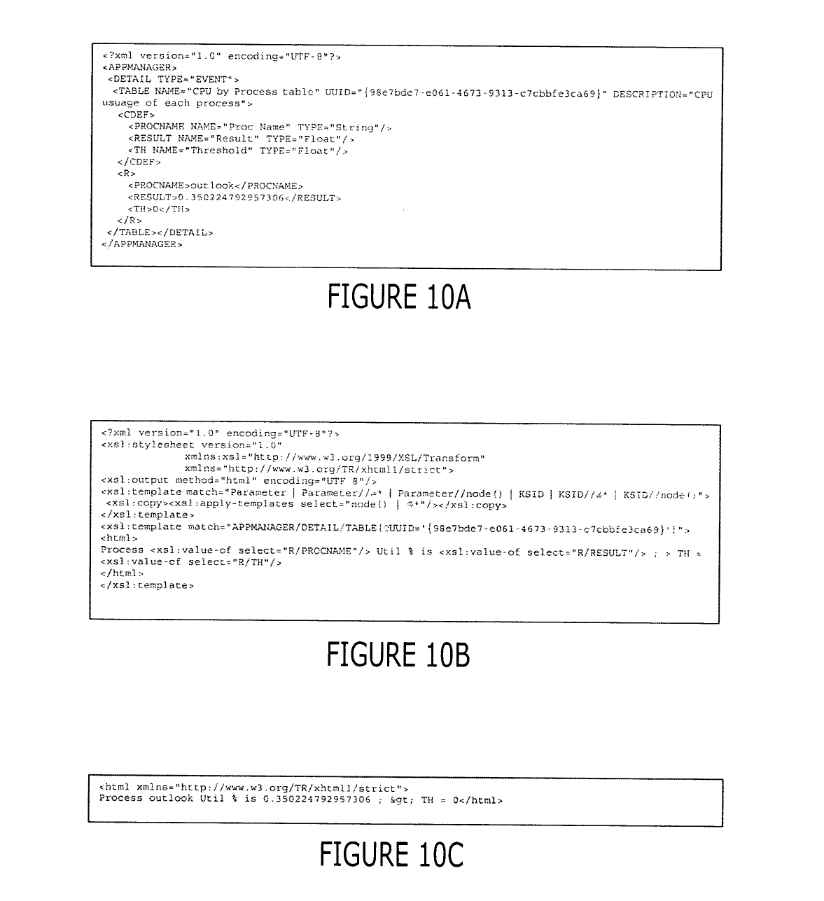

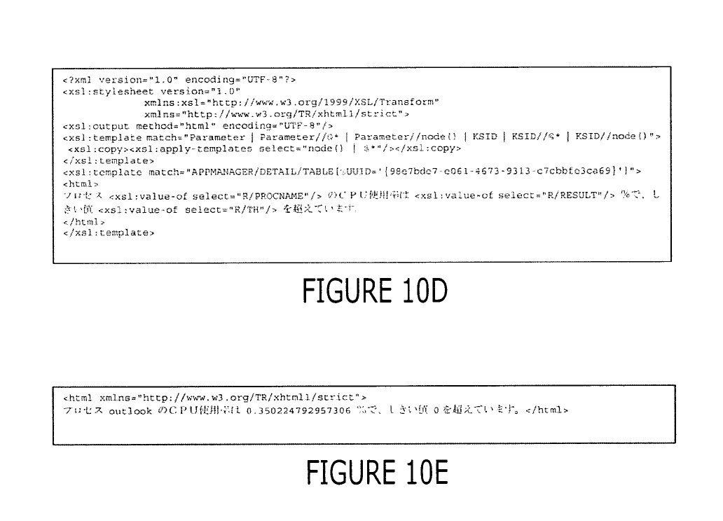

Various embodiments of the present invention will now be described with reference to the exemplary screen display of FIGS. 8A and 8B. The output displays of FIGS. 8A and 8B were generated by embodiments utilizing XML for the language independent markup format of the data record and XSL for the style sheets. XSL is utilized to generate HTML data from data records and the style sheets. The XML input for the graphic display of FIG. 8A is shown in FIG. 10A. As shown in FIG. 10A, the included schema is the information between “CDEF” and “/CDEF”. The data is between “R” and “/R”.

The English language style sheet used for the display of FIG. 8A is shown in FIG. 10B. The resulting HTML output for the display of FIG. 8A is shown in FIG. 10C.

Similarly, FIG. 8B illustrates a Japanese language output provided based on the same input XML (FIG. 10A) as described with reference to FIG. 8A. The XSL style sheet for the display of FIG. 8B is shown in FIG. 10D. The HTML output for the display of FIG. 8B is shown in FIG. 10E.

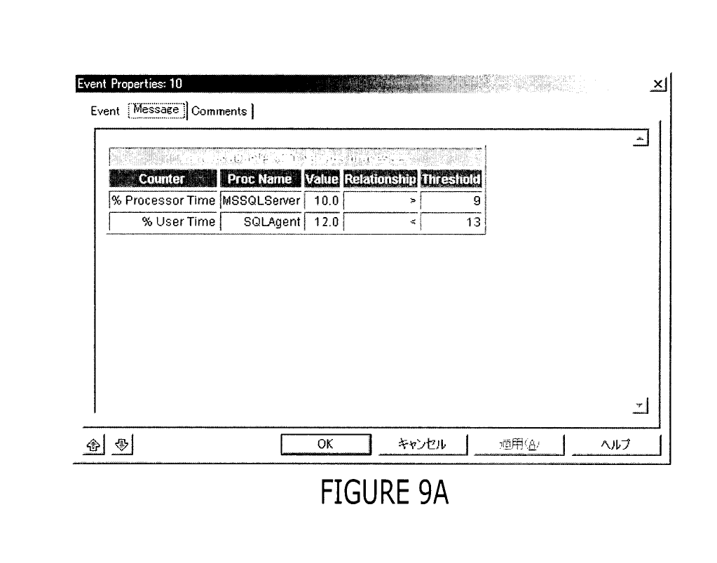

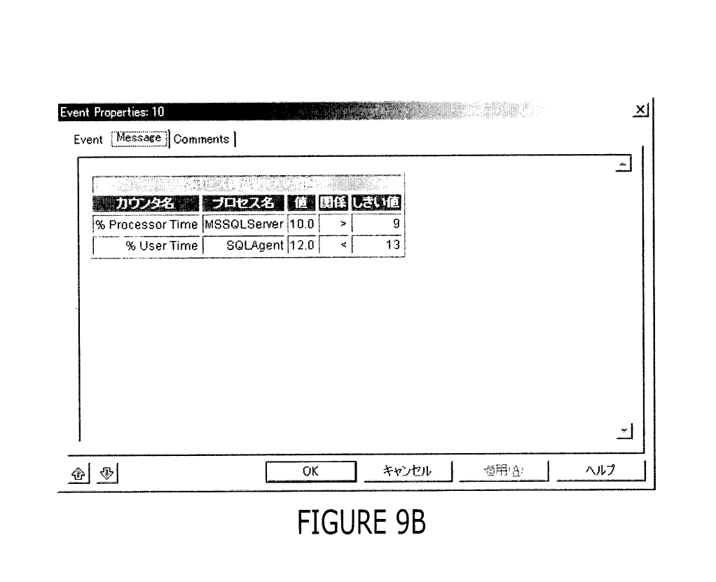

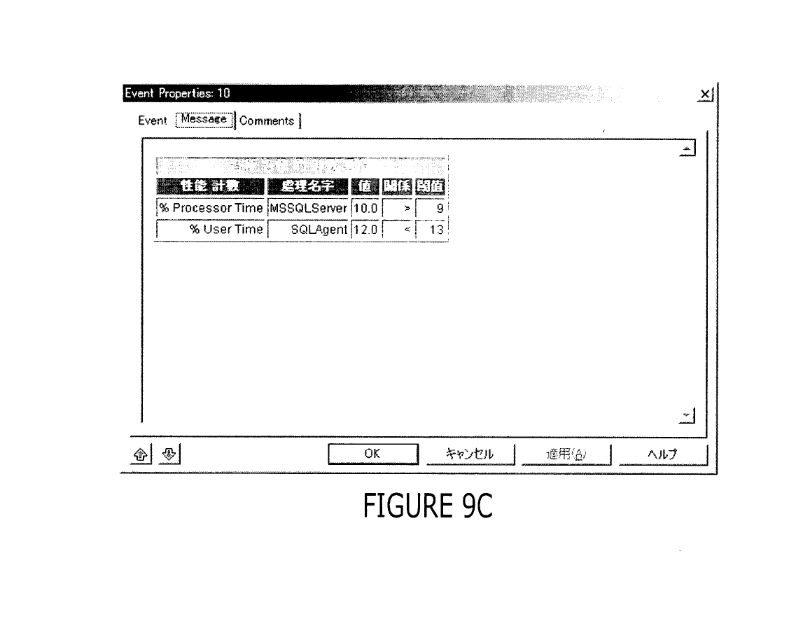

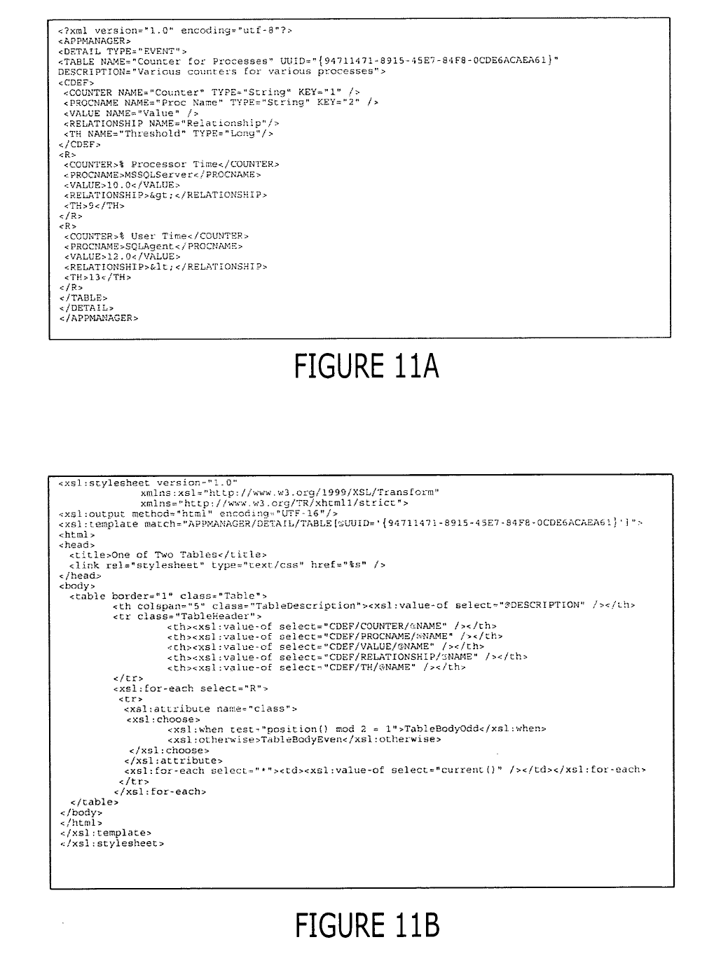

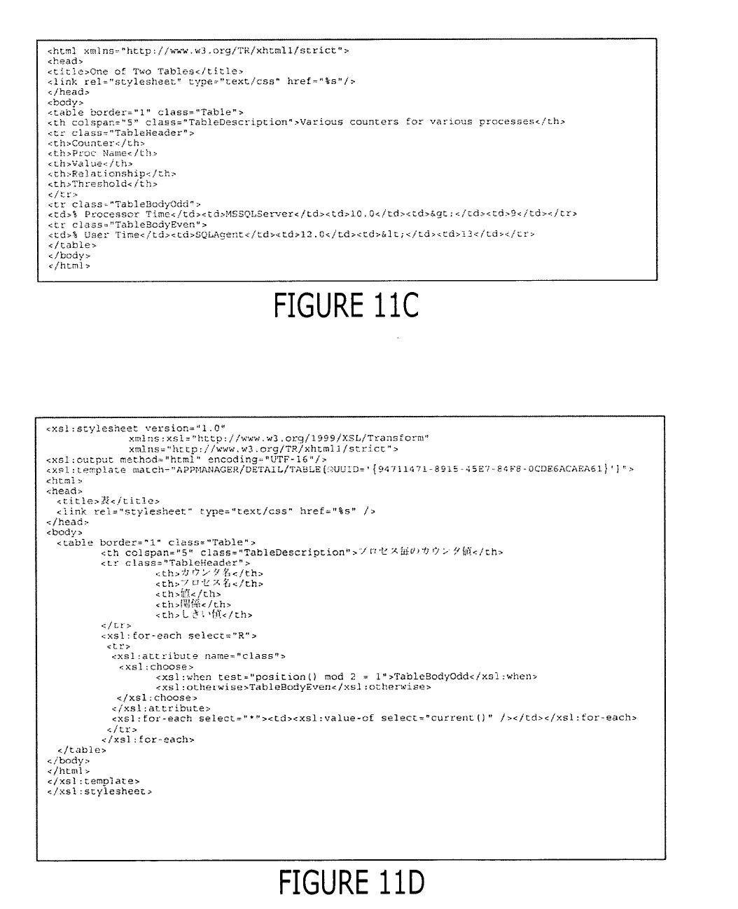

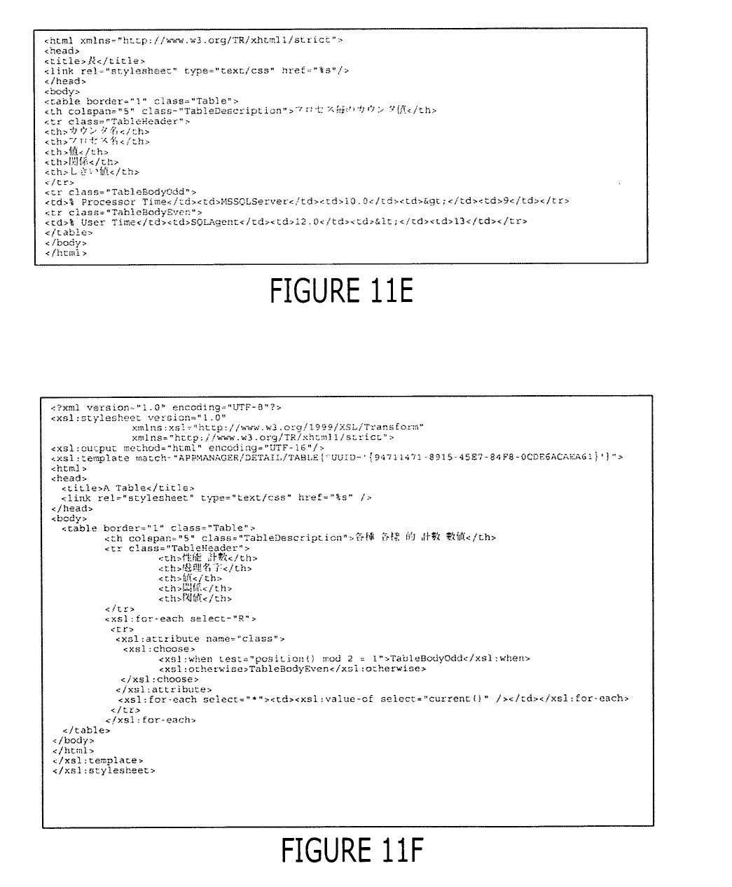

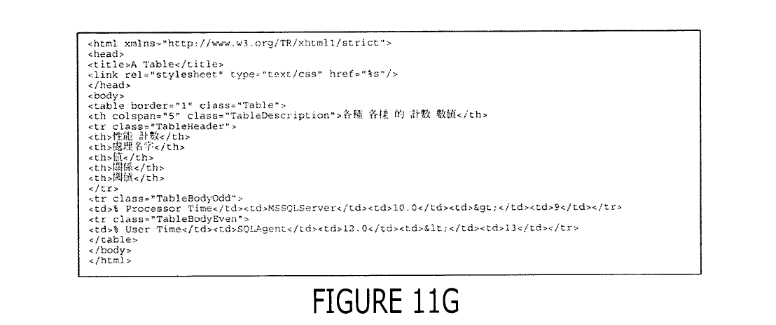

A further example of the screen displays illustrating embodiments of the present invention will now be described with reference to FIGS. 9A through 9C. FIGS. 9A through 9C illustrate embodiments of the present invention generating a table output format for display. The XML input file for the English language output display of FIG. 9A is shown in FIG. 11A. As shown in FIG. 11A, the included schema is the information between “CDEF” and “/CDEF”. The data is between “R” and “/R”.

The English language based XSL style sheet for the display of FIG. 9A is shown in FIG. 11B. The English language HTML output for display of FIG. 9A is shown in FIG. 11C.

FIG. 9B is a Japanese output display corresponding to the English language output display of FIG. 9A. The Japanese language XSL style sheet for the display of FIG. 9B is shown in FIG. 11D. The Japanese language HTML output for FIG. 9B is shown in FIG. 11E.

To further illustrate the language independent conversion of embodiments of the present invention, FIG. 9C illustrates that the same XML input file may be used to generate a variety of different language outputs by illustrating a Chinese language output in FIG. 9C from the same XML input file (FIG. 11A) as used for FIGS. 9A and 9B. FIG. 9C further illustrates that the use of different style sheets for each language may provide for different formatting as well as translation of different text strings as seen from the differences between the displayed header information of the table in FIG. 9C as compared to FIG. 9A and FIG. 9B. In other words, the creator of the Chinese language XSL style sheet associated with FIG. 9C chose not to include the header in Chinese corresponding to the English language “Various counters for various processes”. The Chinese language XSL style sheet for the display of FIG. 9C is shown in FIG. 11F. The Chinese language HTML output for the display of FIG. 9C is shown FIG. 11G.

In further embodiments of the present invention the data record maybe compressed to reduce the amount of memory/bandwidth used for storing/transmitting data records. As seen by the example below, formatting of a data record in accordance with the present invention may significantly increase the record size:

Plain text result (88 bytes):

The counter value exceeded threshold (36 bytes for short message)

The % CPU Utilization of SQLSERVER is 60.0%; >TH=45% (52 bytes for long message)

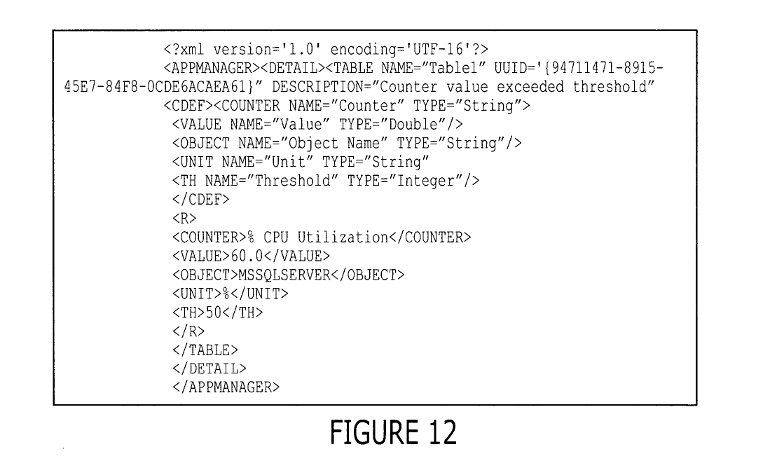

The data record (result of approximately 1100 bytes in Unicode) is shown in FIG. 12.

As described above, the present invention provides, in various embodiments, language independent generation and/or display of formatted data values. Embodiments of the present invention may be particularly beneficial where data is being generated and/or modified in different locations by users working in different languages. Furthermore, the language independent flexibility of exchanging and displaying data of the present invention may be provided while using a single international binary across a variety of different locations. Such an approach may reduce the engineering resources necessary to develop internationalized applications and facilitate use of language independent databases for maintaining and exchanging data (numeric, textual or otherwise) between locations using different languages.

The data may further be formatted locally into a form usable by other applications running at the site receiving the language independent markup formatted data to allow use of data from different locations by other applications executing on the receiving device even though such other applications may be language specific themselves as the formatting of the language using style sheet generates a language specific data format that may be accommodated by other applications, such Microsoft Operations Manager (MOM).

In particular embodiments utilizing XML as the language independent/neutral markup format and XSL for the style sheet, browser type applications that are readily available on most data processing systems may be utilized to facilitate transforming of received XML files into HTML files for display to a user. Furthermore, run time sorting capability for tabular data or event indicators may be provided by using browser applications with dynamic sorting, such as those that support DHTML, Java Applets, third party COM objects or the like as a user interface. Furthermore, the use of a language independent neutral markup format, as contrasted with DLL, may avoid the need for recompiling when changes occur in the structured data format as embodiments of the present invention facilitate changing at run time when the data is known versus compiling or formatting of the data for display.

In accordance with some embodiments of the present invention, language independent data on a computer can be displayed in a desired language using existing technology, such as Windows resource file, a Portable Operating System Interface (POSIX®) message catalog and the like. Embodiments of the present invention may handle complex data structures, such as tabular, nested tabular, and the like where conventional approaches may only support text sentences. In addition, a locale specific formatting (i.e. number, date/time) and the construction data for display may all be maintained in a single location (i.e. style sheet) where various known technology approaches handle locale specific formatting in a program and a formatted string is passed to the display function. Such a conventional approach may divide locale related processes into several places in the program and, as a result, program maintenance may be more difficult. In addition, data may be represented in various formats, such as text-only, graphical, etc. Different languages may be displayed without getting new data. Data may be kept in structured format, and, therefore, there may be no loss in information.

It will be understood that the block diagrams and flowchart illustrations of FIGS. 1 through 7 and combinations of blocks in the block diagrams and flowcharts may be implemented using discrete and integrated electronic circuits and software code. It will also be appreciated that blocks of the block diagrams and flowcharts of FIGS. 1 through 7 and combinations of blocks in the block diagrams and flowcharts may be implemented using components other than those illustrated in FIGS. 1 through 7, and that, in general, various blocks of the block diagrams and flowcharts and combinations of blocks in the block diagrams and flowcharts, may be implemented in special purpose hardware such as discrete analog and/or digital circuitry, combinations of integrated circuits or one or more application specific integrated circuits (ASICs).

Accordingly, blocks of the block diagrams and flowcharts of FIGS. 1 through 7 support electronic circuits and other means for performing the specified operations, as well as combinations of operations. It will be understood that the circuits and other means supported by each block and combinations of blocks can be implemented by special purpose hardware, software or firmware operating on special or general purpose data processors, or combinations thereof. It should also be noted that, in some alternative implementations, the operations noted in the flowcharts of FIGS. 4 and 5 may occur out of the order noted in the figures. For example, two blocks shown in succession may, in fact, be executed substantially concurrently, or the blocks may sometimes be executed in the reverse order.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed:

1. A method for displaying data in a selected language, comprising:
receiving a data record formatted in a language independent markup format;
retrieving a style sheet associated with the selected language;
formatting the data record based on the style sheet; and
displaying the formatted data record in the selected language.

2. The method of claim 1 further comprising:
retrieving a second style sheet associated with a second language different from the selected language;
formatting the data record based on the second style sheet; and
displaying the data record formatted based on the second style sheet in the second language.

3. The method of claim 2 wherein the data record comprises an extensible markup language (XML) file including language independent neutral format data values and wherein the style sheets comprise extensible stylesheet language (XSL) files.

4. The method of claim 3 wherein receiving the data record comprises retrieving the data record from storage.

5. The method of claim 1 further comprising providing a plurality of style sheets associated with different languages and wherein the plurality of style sheets include a locale attribute specifying an associated one of the different languages.

6. The method of claim 1 wherein the data record comprises data collected at a remote location and wherein the remote location displays data using a second language different from the selected language.

7. The method of claim 6 wherein the style sheet contains a plurality of text records in the selected language and wherein the data record contains a plurality of data values in a language independent/neutral format and wherein formatting the data record comprises interspersing the text records with the data values based on the style sheet to provide the formatted data record.

8. The method of claim 7 wherein interspersing the text records with the data values further comprises interspersing the text records with the data values based on tags associated with the data values in the data record.

9. The method of claim 8 wherein the data values are selected from the group consisting of numerical values and event indicators.

10. The method of claim 8 wherein the data record comprises an extensible markup language (XML) file and wherein the style sheet comprises an extensible stylesheet language (XSL) file.

11. The method of claim 8 wherein the data record comprises a message type selected from a plurality of message types each having an associated style sheet and wherein retrieving a style sheet comprises retrieving a style sheet associated with the message type of the data record.

12. The method of claim 8 wherein the data record comprises network resource utilization and/or event indicator data collected by an application manager agent at the remote location.

13. The method of claim 12 wherein the data record comprises a message type selected from a plurality of message types each having an associated style sheet and wherein retrieving a style sheet comprises retrieving a style sheet associated with the message type of the data record.

14. The method of claim 13 wherein the data record includes data collected by one of a plurality of application manager agents and wherein ones of the plurality of application manager agents have associated message types.

15. The method of claim 13 wherein the data record comprises tabular data and wherein formatting the data record comprises sorting the tabular data for display.

16. The method of claim 6 further comprising the following carried out at the remote location:
generating data values at the remote location;
presenting the generated data values in a language independent markup format to provide the data record;
forwarding the data record from the remote location to a location using the selected language; and
wherein the steps of receiving a data record, retrieving a style sheet, formatting the data record and displaying the formatted data record are performed at the location using the selected language.

17. The method of claim 1 wherein the steps of receiving, retrieving, formatting and displaying are performed by a first application program and wherein the method further comprises providing the formatted data record to another application program for further processing.

18. The method of claim 17 wherein the another application program comprises a system management program.

19. The method of claim 1 wherein the received data record includes a schema defining data and a style sheet identifier that identifies the style sheet and wherein retrieving a style sheet comprises retrieving a style sheet based on the style sheet identifier and wherein formatting the data record comprises formatting the data record based on the style sheet and the schema.

20. The method of claim 19 wherein the schema further includes display information in a base language and wherein retrieving a style sheet based on the style sheet identifier comprises retrieving a default style sheet configured to display data in the base language using a default format if the style sheet identifier corresponds to an invalid style sheet at a data processing system receiving the data record and wherein displaying the formatted data record comprises displaying the formatted data record in the base language and the default format.

21. The method of claim 19 wherein the data record includes a plurality of style sheet identifiers.

22. The method of claim 19 wherein the retrieved style sheet specifies a free format table.

23. The method of claim 19 wherein the data record includes a date value and/or a time value in a predefined format and wherein the retrieved style sheet specifies a display format for the date value and/or time value associated with the selected language.

24. The method of claim 1 further comprising providing a plurality of style sheets associated with different languages and wherein the plurality of style sheets include a locale attribute specifying an associated one of the different languages and wherein the retrieved style sheet includes a plurality of data descriptions that specify descriptions for ones of the data values.

25. The method of claim 24 wherein the retrieved style sheet includes at least one unit specification that specifies a language specific unit for at least one of the data values.

26. The method of claim 1 wherein the data record comprises a collaborative editing document.

27. A method for providing data generated at a first data processing system that displays text in a first language to a second data processing system that displays text in a second language different from the first language, the method comprising:
generating data values at the first data processing system;
incorporating the generated data values in a language independent markup document, the language independent markup document including an identification of a style sheet that specifies how to present the data values in the second language, to provide the data record; and
forwarding the data record from the first data processing system to the second data processing system.

28. The method of claim 27 wherein the data record comprises an extensible markup language (XML) file including language independent neutral format data values and wherein the style sheets comprise extensible stylesheet language (XSL) files.

29. The method of claim 27 wherein the data record comprises network resource utilization and/or event indicator data collected by an application manager agent at the first data processing system.

30. The method of claim 27 wherein the data record comprises a message type selected from a plurality of message types each having an associated style sheet and wherein the identification of a style sheet comprises an identification of a style sheet associated with the message type of the data record.

31. The method of claim 30 wherein the data record includes data collected by one of a plurality of application manager agents and wherein ones of the plurality of application manager agents have associated message types.

32. A system for language independent display of data comprising:
a data generation module at a first data processing system that displays text in a first language, the data generation module being configured to:
generate data values;
incorporate the generated data values in a language independent markup document including an identification of a style sheet that specifies how to display text associated with the data values in a second language different from the first language; and
forward the data record from the first data processing system to a second data processing system that displays text in the second language.

33. The system of claim 32 wherein the data generation module comprises a language independent binary.

34. The system of claim 32 further comprising:
a data display module configured to:
receive a data record formatted in a language independent markup format from a data processing system that displays text in a language different from the first language;
retrieve a style sheet that specifies how to display text associated with the data values in the data record in the first language;
format the data record based on the retrieved style sheet; and
display the formatted data values in the first language; and
at least one style sheet associated with the first language.

35. The system of claim 34 wherein at least one of the data display module and the data generation module comprises a language independent binary.

36. The system of claim 35 further comprising at least one second style sheet associated with a language different from the first language.

37. The system of claim 35 wherein the data record comprises a message type selected from a plurality of message types and wherein the at least one style sheet comprises a plurality of style sheets associated with ones of the plurality of message types.

38. The system of claim 37 wherein the identification of a style sheet identifies a plurality of style sheets associated with different languages.

39. The system of claim 35 wherein the data display module and the at least one style sheet are associated with the first data processing system, the system further comprising a second data display module associated with the second data processing system configured to display text in the second language and at least one second style sheet associated with the second language.

40. The system of claim 35 wherein the first language comprises English and at least one of the different languages is selected from the group consisting of German, French, Spanish, Chinese and Japanese.

41. The system of claim 35 wherein the at least one style sheet comprises a plurality of style sheets associated with ones of a plurality of different message types and wherein the data generation module is configured to incorporate generated data values associated with a selected one of the message types in a language independent markup document including an identification of a style sheet associated with the selected one of the message types.

42. The system of claim 41 wherein the data generation module comprises a system management module that generates data values as numerical values and/or event indicators and wherein the data generation module comprises a plurality of data acquisition agent scripts, a first one of the data acquisition agent scripts being associated with a first one of the message types and a second one of the data acquisition agent scripts being associated with a second one of the message types.

43. The system of claim 42 comprising a plurality of data generation modules resident on managed application servers that are configured to gather data from a managed application server on which they reside.

44. A system for language independent display of data in a first language comprising:
a data display module configured to:
receive a data record formatted in a language independent markup format from a data processing system that displays text in a language different from the first language;
retrieve a style sheet that specifies how to display text associated with the data values in the data record in the first language;
format the data record based on the retrieved style sheet; and
display the formatted data values in the first language; and
at least one style sheet associated with the first language.

45. A system for displaying data in a selected language, comprising:
means for receiving a data record formatted in a language independent markup format;
means for retrieving a style sheet associated with the selected language;
means for formatting the data record based on the style sheet; and
means for displaying the formatted data record in the selected language.

46. A system for providing data generated at a first data processing system that displays text in a first language to a second data processing system that displays text in a second language different from the first language, the system comprising:
means for generating data values at the first data processing system;
means for incorporating the generated data values in a language independent markup document, the language independent markup document including an identification of a style sheet that specifies how to present the data values in the second language, to provide the data record; and
means for forwarding the data record from the first data processing system to the second data processing system.

47. A computer program product for displaying data in a selected language, the computer program product comprising:
a computer-readable storage medium having computer-readable program code embodied in said medium, said computer-readable program code comprising:
computer-readable program code that receives a data record formatted in a language independent computer-readable program code that retrieves a style sheet associated with the selected language;
computer-readable program code that formats the data record based on the style sheet; and
computer-readable program code that displays the formatted data record in the selected language.

48. A computer program product for providing data generated at a first data processing system that displays text in a first language to a second data processing system that displays text in a second language different from the first language, the computer program product comprising:
a computer-readable storage medium having computer-readable program code embodied in said medium, said computer-readable program code comprising:
computer-readable program code that generates data values at the first data processing system;
computer-readable program code that incorporates the generated data values in a language independent markup document, the language independent markup document including an identification of a style sheet that specifies how to present the data values in the second language, to provide the data record; and
computer-readable program code that forwards the data record from the first data processing system to the second data processing system.

49. A method for displaying data in a dynamically defined format, comprising:
receiving a data record formatted in a markup format and including a schema and a style sheet identifier;
retrieving a style sheet based on the style sheet identifier;
formatting the data record based on the received schema and the retrieved style sheet to provide the dynamically defined format for display; and
displaying the formatted data record in the dynamically defined format.

50. The method of claim 49 wherein the schema includes display information in a base language and wherein the style sheet identifier comprises an identifier associated with a default style sheet configured to display data for a plurality of schema and wherein displaying the formatted data record comprises displaying the formatted data record in the base language.

51. The method of claim 49 wherein the data record is formatted in a language independent markup format and wherein the style sheet identifier comprises an identifier of a style sheet associated with a selected language and wherein displaying the formatted data record comprises displaying the formatted data record in the selected language.

52. The method of claim 51 wherein the schema includes display information in a base language and wherein the style sheet identifier identifies an unavailable style sheet and wherein formatting the data comprises formatting the data record based on a default style sheet and wherein displaying the formatted data record comprises displaying the formatted data record in the base language.

53. The method of claim 49 wherein the data record includes a plurality of style sheet identifiers.

54. The method of claim 53 wherein the plurality of style sheet identifiers are all associated with a single style sheet.

55. The method of claim 53 wherein at least one of the plurality of style sheet identifiers is associated with a different style sheet than another of the plurality of style sheet identifiers.

56. A method for providing data configured for display in a dynamically defined format, the method comprising:
generating data values at a first data processing system;
incorporating the generated data values in a markup format document;
incorporating a schema in the markup format document that defines a data display format;
incorporating a style sheet identifier in the markup format document that identifies a style sheet that specifies how to format the generated data values for display using the schema; and
forwarding the markup format document from the first data processing system to a second data processing system for display in the dynamically defined format.

57. A system for displaying data in a dynamically defined format comprising:
a data display module configured to:
receive a data record formatted in a markup format and including a schema and a style sheet identifier;
retrieve a style sheet based on the style sheet identifier;
format the data record based on the received schema and the retrieved style sheet to provide the dynamically defined format for display; and
display the formatted data record in the dynamically defined format; and
at least one style sheet identified by the style sheet identifier.

58. A system for providing data generated at a first data processing system to a second data processing system for display in a dynamically defined format, the system comprising a data generation module at the first data processing system configured to:
generate data values at the first data processing system;
incorporate the generated data values in a markup format document;
incorporate a schema in the markup format document that defines a data display format;
incorporate a style sheet identifier in the markup format document that identifies a style sheet that specifies how to format the generated data values for display using the schema; and
forward the markup format document from the first data processing system to a second data processing system for display in the dynamically defined format.
